(19) United States
(12) Patent Application Publication
(10) Pub. No.: US 2008/0114110 A1
(43) Pub. Date: May 15, 2008

(54) ANTISTATIC COMPOSITION AND METHOD OF MANUFACTURING TRANSFER ROLLER USING THE SAME

(76) Inventors: Eun-Chul Lee, Seoul (KR); Kwang-Suck Suh, Seongnam-si (KR); Heui-Soo Moon, Cheonan-si (KR); Tae-Young Kim, Seoul (KR); Chul-Heum Lee, Gyeyung-gu (KR); Do-Yoon Kim, Seoul (KR); Seong-Yeun Kang, Cheonan-si (KR); In-Han Lee, Cheonan-si (KR); In-Shik Park, Cheonan-si (KR); Tue-Hee Lee, Seoul (KR)

Correspondence Address: F. CHAU & ASSOCIATES, LLC, 130 WOODBURY ROAD, WOODBURY, NY, 11797, US

(21) Appl. No.: 11/939,588

(22) Filed: Nov. 14, 2007

(30) Foreign Application Priority Data
Nov. 14, 2006 (KR) 10-2006-0111968

(51) Int. Cl. C08K 5/06; C08K 3/10; H01B 1/00

(52) U.S. Cl. 524/366; 252/500; 524/401

(57) ABSTRACT

An antistatic composition, a transfer roller manufactured by using the antistatic composition, and a method of manufacturing the same are provided. The antistatic composition includes about 0.05 to about 5 parts by weight of an antistatic agent including a metal salt compound, about 10 to about 50 parts by weight of a thermoplastic elastomer, and about 100 parts by weight of a base resin. The antistatic agent includes the metal salt compound and an ether compound. The metal salt compound includes an alkali metal salt compound.

### CROSS-REFERENCE TO RELATED PATENT APPLICATION

This application claims priority to Korean Patent Application No. 2006-0111968, filed Nov. 14, 2006, the disclosure of which is hereby incorporated by reference herein in its entirety.

### BACKGROUND OF THE INVENTION

1. Technical Field

The present invention relates to an antistatic composition, a transfer roller manufactured using the antistatic composition, and a method of manufacturing the same.

2. Discussion of the Related Art

A thin film transistor (“TFT”) liquid crystal display (“LCD”) may be exposed to static electricity during a manufacturing process. The static electricity may cause damages to the TFT LCD by distorting liquid crystal alignment, creating chemical stains, and introducing foreign materials, during the manufacturing process. Thus, a system for eliminating the static electricity may be required to reduce the defect rate.

The static electricity can be prevented by grounding electrical equipment and installing ionizers in the LCD manufacturing process line. In addition, an antistatic treatment can be applied to a transfer roller.

The transfer roller may include a high molecular weight resin such as Teflon and polyacetal. The high molecular weight resin may have dielectric characteristics. The transfer roller may cause friction with a glass substrate so that static electricity can be created. The glass substrate may be damaged by the static electricity. The static electricity may increase the charge amount of the substrate to cause electrostatic stains, impurity absorptions, liquid crystal defects, and the like.

A static electricity discharge may cause damage to TFTs formed on the substrate during the manufacturing process.

### SUMMARY OF THE INVENTION

Embodiments of the present invention provide an antistatic composition, a transfer roller manufactured using the antistatic composition, and a method of manufacturing the same.

In an exemplary embodiment of the present invention, an antistatic composition includes about 0.05 to about 5 parts by weight of an antistatic agent including a metal salt compound; about 10 to about 50 parts by weight of a thermoplastic elastomer; and about 100 parts by weight of a base resin.

The antistatic agent includes the metal salt compound dispersed in an ether compound.

The metal salt compound includes an alkali metal salt compound.

The alkali metal salt compound is at least one selected from the group consisting of perchloric acid lithium (LiClO₄), perchloric acid sodium (NaClO₄), perchloric acid potassium (KClO₄), lithium hexafluoroarsenate (LiAsF₆), lithium tetrafluoroborate (LiBF₄), lithium hexafluorophosphate (LiPF₆), lithium trimethanesulfonate (LiCF₃SO₃), lithium bis(trifluoromethylsulfonyl)imide (LiN(CF₃SO₂)₂), lithium tris(trifluoromethylsulfonyl)methide (LiC(CF₃SO₂)₃), LiPF₆, LiAsF₆, Lil, LiBr, LiSCN, LiSO₃CF₃, LiNO₃, LiC(SO₂CF₃)₃, Li₂S, LiMR₄ (wherein M is A1 or B, and R is a halogen group, an alkyl group, or an aryl group), and a mixture thereof.

The ether compound is at least one selected from the group consisting of polyethylene glycol dimethyl ether, polyethylene glycol distearate, polyethylene glycol dilaurate, and a mixture thereof.

The antistatic agent includes about 1 to about 49 parts by weight of the metal salt compound and about 51 to about 99 parts by weight of the ether compound.

The thermoplastic elastomer is at least one selected from the group consisting of polyurethane elastomer including polyurethane, polyurea and poly(urethane-urea), polyester elastomer including polyetherester and polyesteramide, thermoplastic urethane modified with butadiene or acryl, and a mixture thereof.

The base resin includes a high molecular weight compound having high strength, the high molecular weight compound is at least one selected from the group consisting of polyacetal, high density polyethylene (HDPE), polyamide, polyesterimide, Teflon, polyetheretherketone (PEEK), and a mixture thereof.

The antistatic composition further includes a compatibilizer improving compatibility between the base resin and the antistatic agent.

The compatibilizer is at least one selected from the group consisting of polystyrene grafted or copolymerized with maleic acid, a polymer including an acryl group, a styrene-ethylene-butylene-styrene tetrablock copolymer, a styrene-ethylene-butylene-styrene tetrablock copolymer grafted with maleic acid, a styrene-butadiene-styrene triblock copolymer, a styrene-isobutylene-styrene triblock copolymer, and a mixture thereof.

The acryl group is any one selected from the group consisting of polymethylmethacrylate (PMMA), poly(styrene-acrylonitrile) (SAN), and acrylonitrile-butadiene-styrene (ABS).

The compatibilizer is added in the range of about 0.1 to about 10 parts by weight per 100 parts by weight of the antistatic agent.

The antistatic composition further includes an ionic liquid to improve antistatic properties.

The ionic liquid includes a cationic liquid including alkylimidazolium, alkylphosphonium, N-alkylpyridinium, and N,N′-dialkylimidazolium, and an anionic liquid including a carboxylic acid derivative.

The ionic liquid is added in the range of about 0.01 to about 10 parts by weight per 100 parts by weight of the antistatic agent. According to an exemplary embodiment of the present invention, a method of manufacturing a transfer roller includes forming an antistatic composition by mixing an antistatic agent including a metal salt compound, an ether compound, a base resin, and a thermoplastic elastomer; and molding the antistatic composition in the form of a roller The forming the antistatic composition further comprises adding a compatibilizer.

According to an exemplary embodiment of the present invention, a transfer roller includes an antistatic composition formed by mixing an antistatic agent including a metal salt compound, an ether compound, a base resin, and a thermoplastic elastomer; and the antistatic composition molded in the form of a roller.

The antistatic composition further comprises a compatibilizer.

The antistatic composition further comprises an ionic liquid.

### DESCRIPTION OF EXEMPLARY EMBODIMENTS

The invention is described more fully hereinafter with reference to the accompanying drawings, in which embodiments of the invention are shown. This invention may, however, be embodied in many different forms and should not be construed as limited to the embodiments set for the herein.

An antistatic composition according to an exemplary embodiment of the present invention includes an antistatic agent, a thermoplastic elastomer and a base resin. The antistatic agent is an element allowing the antistatic composition to have conductivity. The antistatic agent is added in the ratio of about 0.05 to about 5 parts by weight per 100 parts by weight of the base resin. When the amount of the antistatic agent is less than about 0.05 parts by weight, the antistatic performance of the antistatic composition may degrade. When the amount of the antistatic agent is greater than about 5 parts by weight, the antistatic performance may not be increased and thermostability of a metal salt compound can be decreased, thus resulting in deterioration of the material.

In an exemplary embodiment, the antistatic agent includes a metal salt compound dispersed in an ether compound. The metal salt compound may include, for example, an alkali metal salt compound having excellent antistatic performance. The alkali metal salt may have ion conductivity by ion dissociation.

The alkali metal salt compound may include at least one selected from the group consisting of perchloric acid lithium (LiClO₄), perchloric acid sodium (NaClO₄), perchloric acid potassium (KClO₄), lithium hexafluoroarsenate (LiAsF₆), lithium tetrafluoroborate (LiBF₄), lithium hexafluorophosphate (LiPF₆), lithium trimethanesulfonate (LiCF₃SO₃), lithium bis(trifluoromethylsulfonyl)imide (LiN(CF₃SO₂)₂), and lithium tris(trifluoromethylsulfonyl)methide (LiC(CF₃SO₂)₃).

Lithium salt compounds such as LiClO₄, LiN(CF₃SO₂)₂, LiPF₆, LiAsF₆, Lil, LiBr, LiSCN, LiSO₃CF₃, LiNO₃, LiC(SO₂CF₃)₃, Li₂S and LiMR₄ (wherein M is A1 or B, and R is a halogen group, an alkyl group, or an aryl group) may be included.

At least two alkali metal salt compounds can be mixed.

The alkali metal salt compound and the ether compound can be mixed in a ratio of about 1 to about 49 parts by weight and about 51 to about 99 parts by weight. When the amount of the ether compound is less than about 51 parts by weight, the alkali metal salt compound may not disperse. When the ether compound is greater than about 99 parts by weight, the amount of the metal salt may be too small. Thus, resulting in a slippery surface of the transfer roller.

The ether compound acts as an auxiliary solvent for facilitating the dispersion of the alkali metal salt compound in the base resin and for securing stable antistatic performance. Accordingly, the ether compound can be a compound having an ether group, an ester group, or an ether-ester group and having a molecular weight of more than about 400 gram/mol. When the molecular weight of the ether compound is less than about 400 gram/mol, the ether compound may volatilize during an extrusion or injection process. The ether compound is mixed with the alkali metal salt compound before the alkali metal salt compound is mixed with the base resin.

The ether compound may be any one selected from the group consisting of polyethylene glycol dimethyl ether, polyethylene glycol distearate, and polyethylene glycol dilaurate.

At least two compounds may be mixed like the ether compound.

The thermoplastic elastomer may improve compatibility of the low molecular weight ether compound and the high molecular weight base resin in the antistatic composition. The transfer roller, having the antistatic composition, may improve mechanical properties of the roller.

In an exemplary embodiment, any thermoplastic elastomers can be used. In addition, any one selected from the group consisting of polyurethane elastomer including polyurethane, polyurea and poly(urethane-urea), polyester elastomer including polyetherester and polyesteramide, and thermoplastic urethane modified with butadiene or acryl can be used.

At least two compounds can be mixed like the thermoplastic elastomers.

The thermoplastic elastomer can be used in the range of about 10 to about 50 parts by weight per 100 parts by weight of the antistatic composition. When the amount of the thermoplastic elastomer is less than about 10 parts by weight, there is no effect of adding the thermoplastic elastomer in the antistatic composition. When the amount of the thermoplastic elastomer is greater than about 50 parts by weight, the antistatic composition may have properties of the thermoplastic elastomer, thus decreasing mechanical strength of the transfer roller required during the manufacturing process.

The base resin may include a high molecular weight compound having excellent mechanical strength for the transfer roller. The high molecular weight compound may be any one selected from the group consisting of polyacetal, high density polyethylene (HDPE), polyamide, polyesterimide, Teflon, and polyetheretherketone (PEEK).

At least two high molecule weight compounds may be mixed like the base resin.

In order to improve the antistatic performance, an ionic liquid may be added to the antistatic composition in accordance with an exemplary embodiment of the present invention. The ionic liquid may be added in the range of about 0.01 to about 10 parts by weight per 100 parts by weight of the antistatic composition. When the amount of the ionic liquid is less than about 0.01 parts by weight, the antistatic performance may not be improved. When the amount of the ionic liquid is greater than about 10 parts by weight, it may cause a decrease in the viscosity of the antistatic composition.

The ionic liquid may be a mixture of a cationic liquid composed of alkylimidazolium, alkylphosphonium, N-alkylpyridinium, N,N′-dialkylimidazolium, and derivatives thereof, and an anionic liquid composed of a carboxylic acid derivative.

In order to improve the compatibility between the base resins, or between the base resin and the antistatic composition, a compatibilizer can be added to the antistatic composition. In an exemplary embodiment, the compatibilizer is added in the range of about 0.1 to about 10 parts by weight per 100 parts by weight of the antistatic composition. When the content of the compatibilizer is less than about 0.1 parts by weight, there is no effect of adding the compatibilizer in the antistatic composition. When the content of the compatibilizer is greater than about 10 parts by weight, the effect on improvement of the compatibility may not increased, and the antistatic composition may have properties of the compatibilizer, thus properties of the antistatic composition may not be enhanced.

The compatibilizer may include a polystyrene grafted or copolymerized with maleic acid, a polymer including an acryl group, a styrene-ethylene-butylene-styrene tetrablock copolymer, a styrene-ethylene-butylene-styrene tetrablock copolymer grafted with maleic acid, a styrene-butadiene-styrene triblock copolymer, a styrene-isobutylene-styrene triblock copolymer, and the like. It is preferred that the acryl group is any one selected from the group consisting of polymethylmethacrylate (PMMA), poly(styrene-acrylonitrile) (SAN), and acrylonitrile-butadiene-styrene (ABS).

At least two compounds may be mixed like the compatibilizer.

With the addition of an appropriate amount of compatibilizer, the compatibility of the respective ingredients may be improved such that the ingredients are uniformly kneaded, thus minimizing the amount of the antistatic agent including the alkali metal salt compound. Deterioration of mechanical properties of the antistatic composition including the alkali metal salt compound, the base resin as a thermoplastic engineering polymer, and the thermoplastic elastomer mixture may be prevented.

A method of manufacturing a transfer roller using the antistatic composition will be described below.

An antistatic agent is prepared by mixing about 1 to about 49 parts by weight of an alkali metal salt compound with about 51 to about 99 parts by weight of an ether compound. The mixture of the alkali metal salt compound and the ether compound is stirred for at least 6 hours to uniformly disperse the alkali metal salt compound. The mixture may be stirred while heating at a temperature in the range of about 60° C. to about 80° C.

An antistatic composition is prepared by adding the antistatic agent, the thermoplastic elastomer, a compatibilizer, and an ionic liquid to the base resin. Since the respective ingredients are the same as described above, their detailed description will be omitted. The ingredients of the antistatic composition may be mixed using any of methods conventionally used for mixing polymers; however, the ingredients may be kneaded using a kneader, a single screw extruder, a twin screw extruder, or the like.

A roller is formed by molding the antistatic composition using any of methods such as compression molding, injection molding, and the like. The molded roller is hardened and is polished, thus completing a transfer roller.

The antistatic performance is measured and compared with respect to three items such as a surface resistance, a frictional static electricity, and a static decay time.

The surface resistance is measured using an electrode designed to measure a point to point resistance with an ST-3 model tester of SIMCO Co. The surface resistance is identified as good when it is less than 1E11Ω; otherwise, it is identified as defective when it is equal to or greater than 1E11Ω.

The frictional static electricity is measured using an FMS-002 model of SIMCO Co. The frictional static electricity of the transfer roller is measured after strongly rubbing the transfer roller with a hand wearing a nitrile glove 10 times. The frictional static electricity is identified as good when it is less than about 100V; otherwise, it is identified as defective when it is equal to or greater than about 100V.

The decay time is measured by using a CPM288 model of Monroe Electronics Inc. The decay time is the time required for an applied charge of about 1000V charged to the transfer roller to decay to about 100V. The decay time is identified as good when it is less than about 3 seconds; otherwise, it is identified as defective when it is equal to or greater than about 3 seconds.

### COMPARATIVE EXAMPLE

An antistatic performance of the conventional transfer roller was measured according to the above-described method.

### Example 1

An antistatic agent was prepared by mixing 4 g of LiN(CF₃SO₂)₂ and 6 g of polyethylene glycol dilaurate and kneading the mixture at a temperature of about 70° C. for about 6 hours. A static composition was prepared by mixing 0.1 g of the antistatic agent with 20 g of polyester elastomer and 80 g of polyacetal resin and kneading the mixture using a twin screw extruder. After molding the antistatic composition in the form of a rod, a transfer roller was manufactured through a polishing process.

### Example 2

Example 2 was carried out in the same manner as Example 1, except that 1 g of poly(styrene-ethylene-butylene-styrene) block copolymer grafted with maleic acid was added as a compatibilizer during the preparation of the antistatic composition. This Example verifies the effect of the compatibilizer.

### Example 3

Example 3 was carried out in the same manner as Example 2, except that 2 g of the antistatic agent prepared by mixing LiN(CF₃SO₂)₂ and polyethylene glycol dilaurate was used. This Example compares the effects of the antistatic agent according to the used amount.

### Example 4

Example 4 may be performed in the same manner as Example 2, except that 0.5 g of an ionic liquid composed of butylmethylimidazolium and ethylhexanoate was added to the antistatic composition. This Example is required to verify the effect of the ionic liquid.

Antistatic performances measured in Comparative Example and Examples 1 to 4 are shown in the following table 1:

TABLE 1

| | | Comparative | | | | |
|---|---|---|---|---|---|---|
| | | Example | Example 1 | Example 2 | Example 3 | Example 4 |
| Surface | Point to Point | >1E12 | 1E10 | 1E10 | 1E9 | 1E8 |
| Resistance | Resistance (Ω) | | | | | |
| | Resistance to | >1E12 | >1E11 | 1E10 | 1E9 | 1E8 |
| | Ground (Ω) | | | | | |

| | | | | | |
|---|---|---|---|---|---|
| Friction Voltage (V) | ≈7000 | <70 | <50 | <10 | <10 |
| Decay Time (sec) | >300 | <0.5 | <0.1 | <0.1 | <0.1 |
| Substrate Charge (V) | ≈4000 | <100 | <100 | <100 | <50 |
| Surface Hardness (H) | 5 | 3 | 5 | 5 | 5 |

As shown in table 1, the transfer rollers of the Examples in accordance with an exemplary embodiment of the present invention have improved antistatic performance compared with the conventional transferring roller.

As described above, the transfer roller manufactured according to an exemplary embodiment of the present invention may have no moisture dependency and have permanent surface resistance.

Since the antistatic composition is prepared using a material having no risk of generating particles, particles are generated during the use of the transfer roller manufactured using the antistatic composition of the present invention.

Although the exemplary embodiments of the present invention have been described herein with reference with the accompanying drawings, it is understood that the present invention is not be limited to these exemplary embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. An antistatic composition comprising:
about 0.05 to about 5 parts by weight of an antistatic agent including a metal salt compound;
about 10 to about 50 parts by weight of a thermoplastic elastomer; and
about 100 parts by weight of a base resin.

2. The antistatic composition of claim 1, wherein the antistatic agent comprises the metal salt compound and an ether compound,
wherein the metal salt compound comprises an alkali metal salt compound.

3. The antistatic composition of claim 2, wherein the alkali metal salt compound is at least one selected from the group consisting of perchloric acid lithium (LiClO₄), perchloric acid sodium (NaClO₄), perchloric acid potassium (KClO₄), lithium hexafluoroarsenate (LiAsF₆), lithium tetrafluoroborate (LiBF₄), lithium hexafluorophosphate (LiPF₆), lithium trimethanesulfonate (LiCF₃SO₃), lithium bis(trifluoromethylsulfonyl)imide (LiN(CF₃SO₂)₂), lithium tris(trifluoromethylsulfonyl)methide (LiC(CF₃SO₂)₃), LiPF₆, LiAsF₆, Lil, LiBr, LiSCN, LiSO₃CF₃, LiNO₃, LiC(SO₂CF₃)₃, Li₂S, LiMR₄ (wherein M is A1 or B, and R is a halogen group, an alkyl group, or an aryl group), and a mixture thereof.

4. The antistatic composition of claim 3, wherein the ether compound is at least one selected from the group consisting of polyethylene glycol dimethyl ether, polyethylene glycol distearate, polyethylene glycol dilaurate, and a mixture thereof.

5. The antistatic composition of claim 2, wherein the antistatic agent comprises about 1 to about 49 parts by weight of the metal salt compound and about 51 to about 99 parts by weight of the ether compound.

6. The antistatic composition of claim 2, wherein the thermoplastic elastomer is at least one selected from the group consisting of polyurethane elastomer including polyurethane, polyurea and poly(urethane-urea), polyester elastomer including polyetherester and polyesteramide, thermoplastic urethane modified with butadiene or acryl, and a mixture thereof.

7. The antistatic composition of claim 2, wherein the base resin is a high molecular weight compound having high strength, and wherein the high molecular weight compound is at least one selected from the group consisting of polyacetal, high density polyethylene (HDPE), polyamide, polyesterimide, Teflon, polyetheretherketone (PEEK), and a mixture thereof.

8. The antistatic composition of claim 2 further comprising a compatibilizer improving compatibility between the base resin and the antistatic agent.

9. The antistatic composition of claim 8, wherein the compatibilizer is at least one selected from the group consisting of a polystyrene grafted or copolymerized with maleic acid, a polymer including an acryl group, a styrene-ethylene-butylene-styrene tetrablock copolymer, a styrene-ethylene-butylene-styrene tetrablock copolymer grafted with maleic acid, a styrene-butadiene-styrene triblock copolymer, a styrene-isobutylene-styrene triblock copolymer, and a mixture thereof.

10. The antistatic composition of claim 9, wherein the acryl group is any one selected from the group consisting of polymethylmethacrylate (PMMA), poly(styrene-acrylonitrile) (SAN), and acrylonitrile-butadiene-styrene (ABS).

11. The antistatic composition of claim 9, wherein the compatibilizer is added in the range of about 0.1 to about 10 parts by weight per 100 parts by weight of the antistatic agent.

12. The antistatic composition of claim 8 further comprising an ionic liquid.

13. The antistatic composition of claim 12, wherein the ionic liquid comprises a cationic liquid including alkylimidazolium, alkylphosphonium, N-alkylpyridinium, and N,N′-dialkylimidazolium, and an anionic liquid including a carboxylic acid derivative.

14. The antistatic composition of claim 13, wherein the ionic liquid is added in the range of about 0.01 to about 10 parts by weight per 100 parts by weight of the antistatic agent.

15. A method of manufacturing a transfer roller, the method comprising:
forming an antistatic composition by mixing an antistatic agent comprising a metal salt compound, an ether compound, a base resin, and a thermoplastic elastomer; and
molding the antistatic composition in the form of a roller.

16. The method of claim 15, wherein forming the antistatic composition further comprises adding a compatibilizer.

17. The method of claim 15, wherein forming the antistatic composition further comprises adding an ionic liquid.

18. A transfer roller comprising:
an antistatic composition formed by mixing an antistatic agent comprising a metal salt compound, an ether compound, a base resin, and a thermoplastic elastomer; and
the antistatic composition molded in the form of a roller.

19. The transfer roller of claim 18, wherein the antistatic composition further comprises a compatibilizer.

20. The transfer roller of claim 18, wherein the antistatic composition further comprises an ionic liquid.
